(19) United States
(12) Patent Application Publication
(10) Pub. No.: US 2011/0233281 A1
(43) Pub. Date: Sep. 29, 2011

(54) RACE BIB TIMING DEVICE

(76) Inventor: Daniel R. Howell, NEWBURGH, IN (US)

(21) Appl. No.: 12/856,587

(22) Filed: Aug. 14, 2010

Related U.S. Application Data
(63) Continuation-in-part of application No. 12/732,590, filed on Mar. 26, 2010.

(51) Int. Cl. G06K 19/067; G06K 19/02

(52) U.S. Cl. 235/488; 235/492

(57) ABSTRACT

A disposable race bib timing device is provided including a thin, flexible planar sheet member having a front surface for displaying information, and a rear surface. A pair of RFID timing tags are provided on the rear surface of the flexible planar bib. The RFID timing tags are spaced a distance apart from one another and positioned in parallel in relation to one another. A thermal and moisture resistant layer of material is provided over the exposed outer surface of each RFID tag to prevent moisture and heat from the athlete from coming into contact with the RFID tag and interfering with the ability of the tag to communicate with the antenna of a corresponding timing system. A further waterproof layer of material may be positioned between each RFID tag and the race bib to prevent moisture from soaking through the bib into the RFID tag. A laminate material may be provided to cover the entire surface.

### FIELD OF THE INVENTION

The invention relates to electronic timing and location devices worn by endurance athletes competing in races, and specifically relates to an improved race timing tag that is incorporated directly in the race bib, and includes two or more disposable UHF RFID tags having chips upon which data can be encoded for purposes of collecting data on an athlete during a race.

### BACKGROUND OF THE INVENTION

The human spirit is competitive. Since earliest times men and women have run and raced against each other. The basic race consists of a start where someone says “GO” and everyone races to the finish line—first one across wins. A stopwatch can be used to determine the winning time.

It is easy to spot the winners—they are at the front, but it is not so simple to determine who is say “400^{th}”. Today, every runner wants to know how he or she did compared to other runners and to their “personal best” time. They want to know if they are “400^{th}” or “401^{st}”. To know that, an accurate, recorded time needs to be generated for every runner.

In a large race today, there are thousands of runners. Systems need to capture a start-time for every runner and to track when they cross the finish line, then use that data to compute that runner's elapsed time. In long races, runners also want to know what their “split times” are. They want to know what their times were when they crossed certain mile markers during the race. Further sophistication now requires that these times be posted on the internet in real time so that relatives and loved ones can use the runner's number to see when their runner passed these points.

The present invention meets that need with an improved UHF RFID timing tag on the runner's bib and portable readers connected via the cellular network.

RFID has been used in race timing systems since 1986. Before the present invention, all of these systems used a returnable RFID chip that was attached to the runner and had to be returned to the timer following the race. These systems have significant limitations. First, the timer must build a cross-link file that correlates the unique RFID chip number to the runner's bib number. This process of building this file is time consuming and error prone. Second, after the race, each runner must wait in line to have his or her RFID chip “clipped” and returned to the timer. The event coordinator must ensure that there are sufficient volunteers to collect these RFID chips and there must be a sufficiently large and secure area to support this chip collection. If chips are not returned, the event is liable and must pay the timer for lost chips. In addition, the prior art chips are bulky and expensive to mail, so pre-registration options to improve race starts cost the event money—a not insignificant trade off. Further, the RFID controller on prior art systems is susceptible to electromagnetic interferences and must be tuned. Finally, the prior art chip controller does not have an integrated screen requiring this unit to operate externally with cables, more pieces, more packing and unpacking for the timer.

The present invention overcomes these limitations by providing a system that uses low cost, disposable UHF Gen 2 RFID Tags. The use of this tag eliminates the need for chip assignment, the cost of shipping chips to events or participants, lost chip costs and the need to create a secure zone for chip collection. The elimination of the costs for these processes directly affects the events' and timers' bottom lines. On race day, the timer can now benefit from a system that is over 99.8% accurate, does not have to be tuned, does not suffer from interference from spurious EMI sources, can be powered by its internal Li-ion batteries, external car batteries, AC generators and/or AC socket in the back of a vehicle.

### SUMMARY OF THE INVENTION

The present invention provides an all-weather option that is better suited to the logistics and pace of today's style of events. The present invention includes Gen2 UHF RFID tags that are used to track a runner's process during a race. The tags are incorporated directly into the runner's race bib and are comprised of disposable plastic strips about the size of bandages and has a tiny computer chip and antenna embedded in the plastic strip. The RFID tags are configured and encoded data that uniquely identifies the race and the runner's “bib” number. The RFID tag is then attached to back of the runner's bib and included in the runner's race packet. These bibs are then either mailed or hand delivered to the runner at the race expo. On race day, the athlete simply attaches the race bib to his/her shirt or shorts in the conventional manner and he/she is ready to begin the race. Because the tag is disposable, following the race, the runner simply removes the race bib and can dispose of it.

According to one aspect of the present invention, there is provided a disposable race bib timing device including a thin, flexible planar sheet member having a front surface for displaying information, and a rear surface. A plurality of RFID timing tags are affixed to the flexible planar sheet member. Each of the RFID timing tags includes a rear surface engaging one of either the front surface or rear surface of the thin flexible planar sheet member. The plurality of RFID timing tags are spaced a distance apart from one another and positioned in parallel in relation to one another. A thermal and moisture resistant layer of material is also provided between each one of the plurality of RFID timing tags and the participant's garments to protect the RFID tag from interference caused by heat and moisture from the athlete.

According to a further aspect of the invention, the RFID timing tags are affixed to the rear surface of the thin flexible planar sheet member. Yet another aspect of the invention comprises utilization of two RFID timing tags.

A further aspect of the invention provides that each RFID timing tag comprises a thin, flexible planar sheet member having a front surface, and a rear surface, and a printed radio frequency identification (RFID) circuit disposed on one of the front or rear surfaces of the sheet member. The RFID circuit is disposed on the rear surface of the sheet member, according to one preferred aspect. According to this aspect of the invention, the RFID circuit includes an integrated circuit chip positioned near the center of the planar sheet member, and a dipole antenna electrically coupled to the integrated circuit chip. A first dipole of the antenna extends generally along a longitudinal axis of the sheet member toward a first end thereof and a second dipole of the antenna extends generally along the longitudinal axis of the sheet member toward a second end thereof. According to a further aspect of the invention, the first and second dipoles of the antenna extend substantially to the respective first and second ends of the flexible planar sheet. The width of the first and second dipoles of said antenna may also extend substantially across the width of the flexible planar sheet member, according to yet another aspect of the present invention.

A further aspect of the present invention provides a disposable race bib timing device wherein the thermal and moisture resistant layer of material is comprised of closed cell foam, which may preferably be between 10 and 12 mil thick.

According to yet another aspect of the invention, the disposable race bib timing device further comprises a water-proof layer of material positioned between the thin, flexible planar sheet member and each of the RFID timing tags. A water-resistant laminate material having a rear surface fully covering the plurality of RFID timing tags and the thermal and moisture resistant layer of material may also be provided.

Yet a further aspect of the invention is a disposable race bib timing device wherein the RFID timing tags are positioned on a rear surface of the thin, flexible planar sheet member and the thermal and moisture resistant material has a rear surface engaging a front surface of each one of the RFID tags. A water-proof layer of material may be positioned between the thin, flexible planar sheet member and each of the plurality of RFID timing tags. A water-resistant laminate material having a rear surface engaging and fully covering a front surface of the thermal and moisture resistant layer of material may also be provided.

According to an alternative aspect of the invention, the thermal and moisture resistant material is positioned on a front surface of the thin, flexible planar sheet member. The plurality of RFID tags each have a rear surface engaging a front surface of each one of the thermal and moisture resistant material layers. A water-proof layer of material may be positioned between the thin, flexible planar sheet member and each one of the plurality of RFID timing tags. The water-proof layer of material may be positioned between the thin, flexible planar sheet member and the thermal and moisture resistant layer. The disposable race bib timing device may further comprise a water-resistant laminate material having a rear surface engaging and fully covering a front surface of each of the plurality of RFID timing tags.

Accordingly, it is an object of the present invention to provide a low cost, disposable RFID timing tag that eliminates the need for chip assignment, the cost of shipping chips to events or participants, lost chip costs and the need to create a secure zone for chip collection.

It is a further object of the present invention to provide a disposable timing tag that can accurately record information about multiple athletes at multiple locations.

These and other objects, features and advantages of the present invention will become apparent with reference to the text and the drawings of this application.

### BRIEF DESCRIPTION OF THE DRAWINGS

FIG. 1 is front plan view of a race bib timing device according to one preferred embodiment of the present invention.

FIG. 2 is a rear plan view of the race bib timing device shown in FIG. 1.

FIG. 3 is an exploded perspective view of one of the timing tags of the race bib timing device shown in FIGS. 1 and 2.

FIG. 4 is an exploded perspective view of one of the timing tags according to an alternative embodiment of the present invention, positioned on the back side of a race bib.

FIG. 5 is an exploded perspective view of one of the timing tags according to an alternative embodiment of the present invention, positioned on the front side of a race bib.

### DETAILED DESCRIPTION OF PREFERRED EMBODIMENTS

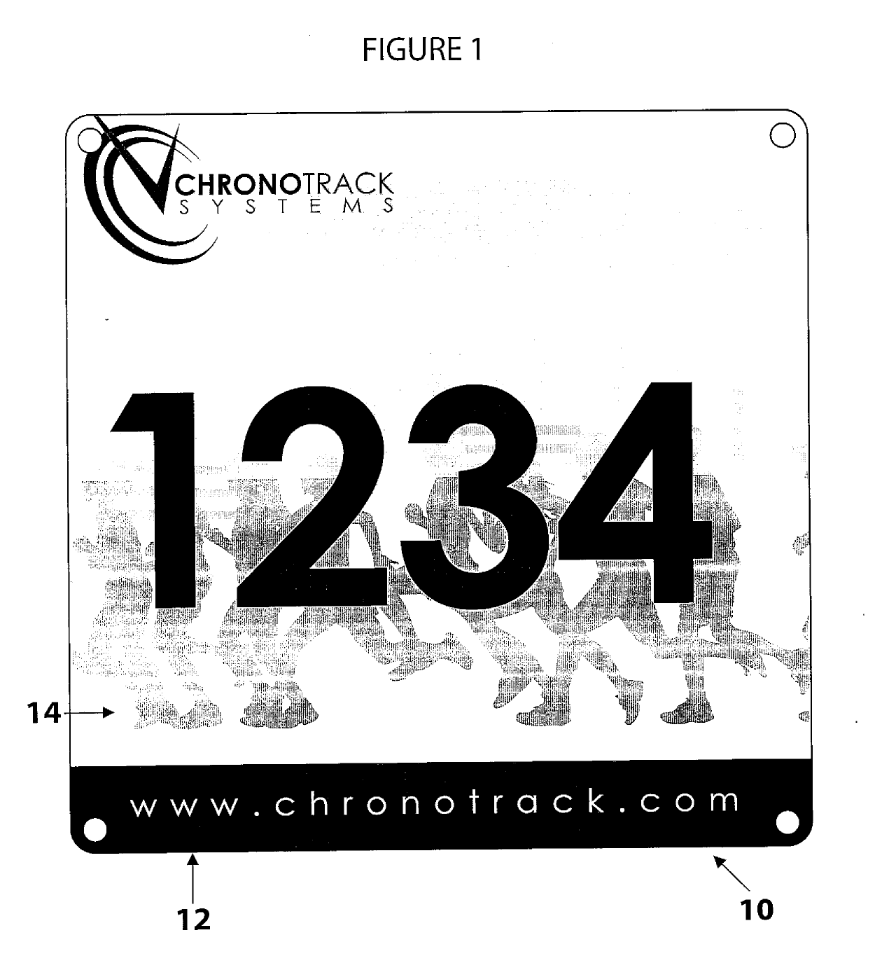

FIGS. 1-3 illustrate an improved race bib timing device 10 according to a presently preferred embodiment of the present invention. According to the presently preferred embodiment, the improved race bib timing device includes a race bib 12, having a front surface 14 and a rear surface 16. The race bib 12 is preferably formed of a planar, paper-like material that can be removably affixed to the shirt, shorts or other garment of a participant in an event such as a marathon, road race, track and field event, cross country race, skiing event, biking event, triathlon, or other sporting event where participants are assigned a number for timing and/or ranking purposes. In many instances, the race bib 12 is formed of a water proof and tear resistant material, such as TYVEK. The front surface 14 of the race bib 12 can be used to display data and information, including, but not limited to the participant's assigned entry or race number, the name of the race, or other desired information. The rear surface 16 of the race bib 12 is typically devoid of any such information as it is commonly placed against the outer surface of the participant's garment when in use.

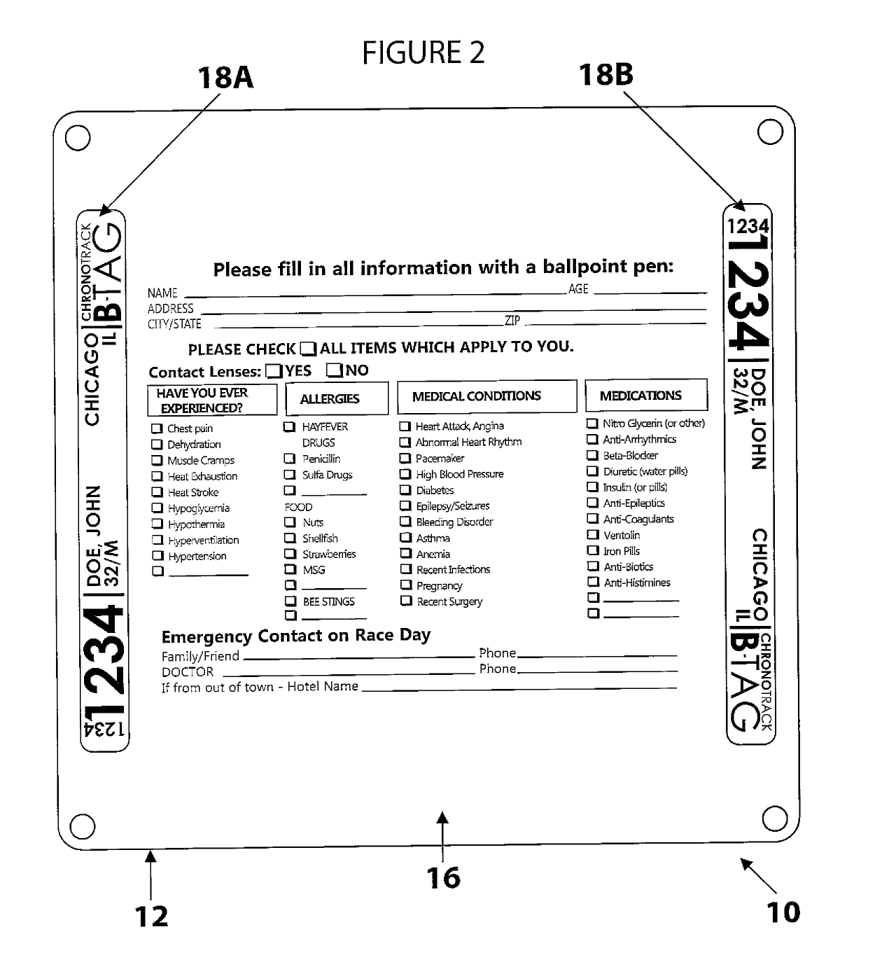

According to the present invention, two or more timing tags 18a, 18b are associated with the race bib 12 for obtaining timing information about the participant when used in conjunction with a race timing system and readers. As shown in FIG. 2, according to one embodiment of the present invention, two timing tags 18a, 18b are positioned on the rear surface 16 of the race bib 12. It is also contemplated that the timing tags could be located on the front surface 14 of the race bib 12, or embedded within the race bib itself, or that more than two timing tags could be utilized. As shown in FIG. 2, the two or more timing tags 18a, 18b are positioned parallel to one another such that the antennae therein are linearly polarized relative to one another. The two or more timing tags 18a, 18b are also positioned on the race bib 12 such that, when the bib is affixed to the garment of the participant, the timing tags 18a, 18b are oriented such that they are perpendicular to the tag reader. For example, where reader antennae are employed in a ground-based antenna reader system such as is described in applicant's corresponding provisional patent application Ser. No. 61/182,520, the timing tags 18a, 18b should be oriented such that, when applied to the garment of the participant, they are oriented vertically relative to the ground and the antenna reader.

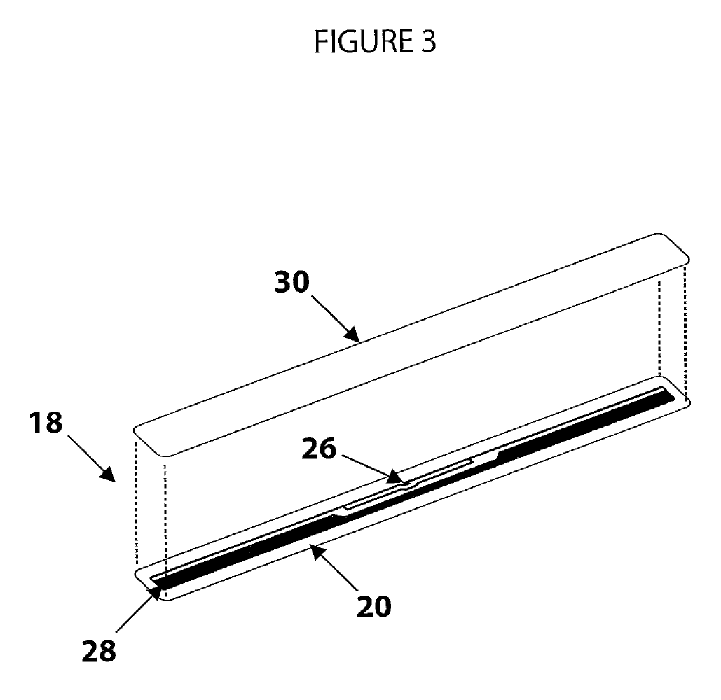

As best shown in FIG. 3, each timing tag 18 is a preferably planar member 20, preferably having a substantially rectangular cross-section, and is preferably formed of a flexible, water resistant sheet type material having very low conductivity, such as sheet plastic or laminated paper. An integrated circuit 26 and antenna 28 are formed on the planar member 20 of the timing tag 18. The integrated circuit 26 and antenna 28 are preferably formed on the rear surface of the timing tag 18 to protect those components from the elements. It is also contemplated that the integrated circuit 26 and/or antenna 28 be formed on the front surface of the planar member 20 of the timing tag 18. The integrated circuit 26 is used for storing and processing information, modulating and demodulating a radio-frequency (RF) signal and other specialized functions. The integrated circuit 26 includes memory circuits and logic circuits. The logic circuits store, retrieve, and manipulate data that is encoded into the memory circuits. The logic circuits of the integrated circuit 26 receive and transmit data externally from the timing tag 18 via RF signals. The timing tag is preferably a passive RFID tag, which has no battery and requires an external source to provoke signal transmission. Alternatively, the timing tag 18 could be an active RFID tag, which contains a battery and can transmit signals autonomously.

The antenna 28 is electrically connected to the integrated circuit 26 and is configured for receiving and transmitting the signal. The antenna 28 picks up signals from an RFID reader or scanner and then returns the signal, with some additional data—in this case, the runner's bib number and related information that has previously been encoded on the memory circuits of the integrated circuit 26. The antenna 28 is a conductive element that permits the timing tag 18 to exchange data with a remote reader. The antenna array is large relative to the surface of the timing tag to permit the data to be read at a distance from the transmitting antenna.

Passive RFID tags, such as are contemplated in the preferred embodiment of the present invention, make use of a coiled antenna that can create a magnetic field using the energy provided by the reader's carrier signal. A passive tag does not contain a battery; the power is supplied by the reader. When radio waves from the reader are encountered by a passive RFID tag, the coiled antenna within the tag forms a magnetic field. The tag draws power from it, energizing the circuits in the tag. The tag then sends the information encoded in the tag's memory to the reader.

The integrated circuit 26 and antenna 28 comprise a singular structure with a printed RFID circuit, thereby minimizing its profile and weight. According to one preferred embodiment of the invention, a DogBone RFID tag manufactured by UPM Raflatac is utilized. The integrated circuit used is EPC Class 1 Gen 2 compliant and 96 bit EPC memory is provided. The integrated circuit operates at a frequency of 860-960 MHZ. The antenna measures approximately 93×23 mm. Other antenna configurations and integrated circuits may be used in keeping with the spirit of the invention.

It has been discovered through testing that the RFID tag does not operate to its potential when the integrated circuit and antenna are allowed to come in contact with moisture and heat that may be present on the surface of the participant's garment and/or skin It has also been discovered that, without the use of some shielding layer, the participant's body absorbs some of the energy from the integrated circuit 26 and antenna 28, resulting in errors. Thus, in order for the RFID tag to operate properly, in use as a timing tag, it is necessary to insure that moisture and heat from the participant do not interfere with the integrated circuit 26 and antenna 28. This is accomplished by providing a protective layer or coating 30 between the timing tag 18 and the participant. According to one presently preferred embodiment, the protective layer or coating 30 is a product known as RFIDefend produced by MPI Label Systems. The RFIDefend has a unique and proprietary material construction that provides added protection to the inlay in applications where the RFID tag is subjected to impact, abrasion, heat or moisture. It also allows the entire label to be printed without quality interference from the chip and withstands exposure to outdoor elements. According to an alternative preferred embodiment, the protective layer or coating 30 is comprised of closed cell foam. The thickness of the closed cell foam can be varied based on the particular needs of the user. However, for most purposes, providing a layer of closed cell foam in the range of 10-12 ml has been found to produce satisfactory results. Although only a single protective layer or coating 30 is shown in FIG. 3, it is contemplated to provide multiple layers and/or coatings and/or coatings of varying thicknesses to achieve the desired isolation of the RFID tag from heat and moisture from the athlete.

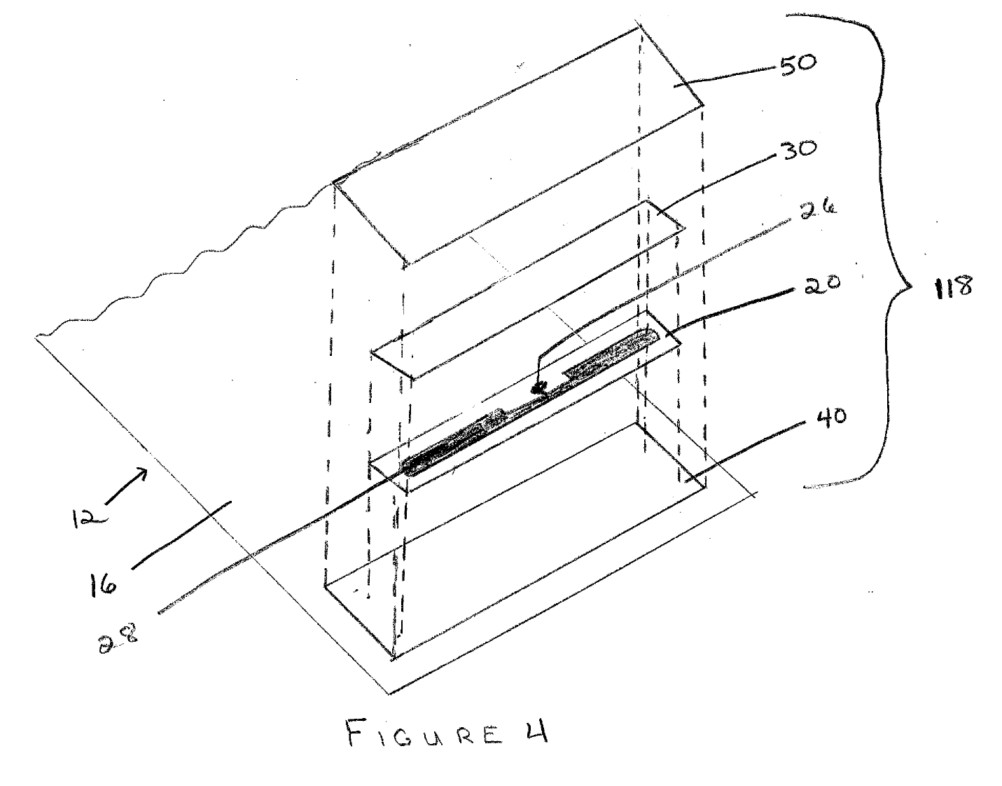

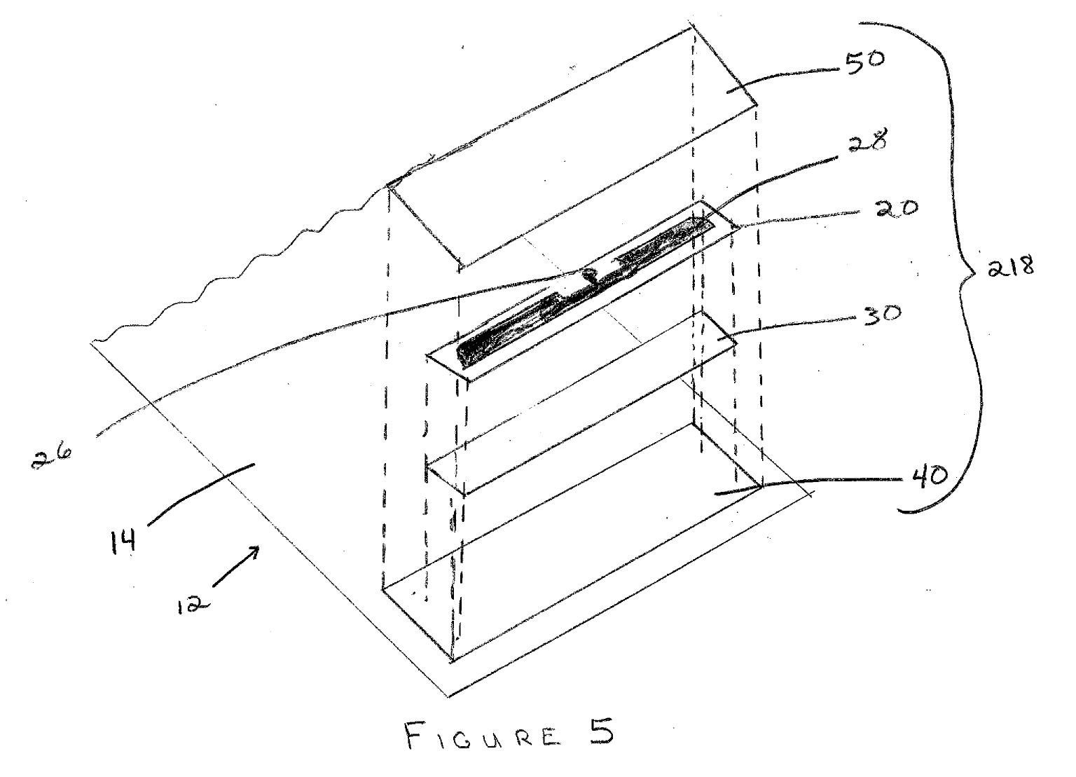

It has been discovered further through testing that over longer periods of time and in longer races (typically longer than 10K) the water resistance of the TYVEK bib material breaks down and moisture in the form of water and/or sweat may come into contact with the integrated circuit 26 and antenna 28 causing a decline in read rates of the tags as they pass over the readers. The same problem exists in shorter races where standard, non-TYVEK, paper tags are used. This problem can be overcome by providing additional water-proof and/or water-resistant layers as best shown in FIGS. 4 and 5.

In FIG. 4, a timing tag 118 according to an alternative embodiment is shown. The timing tag according to this embodiment is positioned on the back side 16 of the race bib 12, and includes additional water-proof and/or water-resistant layers 40 and 50 to protect the integrated circuit 26 and antenna 28 from moisture that may soak through the bib 12 over time. The planar member 20, integrated circuit 26, antenna 28 and protective layer or coating 30 are as described above and, accordingly, will not be further described here.

The first water-proof layer 40 is positioned between the bib 12 and the planar member 20 to prevent moisture in the form of water and/or sweat from soaking through the bib and coming into contact with the integrated circuit 26 and antenna 28. The first water-proof layer 40 acts as a vapor/water barrier between the bib 12 and planar member 20, and may be formed of any suitable water-proof material. According to one preferred embodiment of the present invention, the first water-proof layer 40 is formed from a thin sheet of polypropylene material. The second water-proof layer, or overlay, 50 is used to provide an outer water-proof seal or laminate over the planar member 20 and may also be formed of any suitable water-proof or water-resistant material. According to one preferred embodiment of the present invention, the second water-proof layer 50 is formed of a thin layer of synthetic polymer material such as nylon or polyethylene.

The primary difference between the tag 118 shown in FIG. 4 and the tag 218 shown in FIG. 5, is the positioning of the protective layer 30. As previously mentioned, the protective layer 30 must be positioned between the participant's body and the integrated circuit 26 and antenna 28 to shield the absorption of energy from the integrated circuit 26 and antenna 28 by the participant's body. Thus, when the tag 118 is positioned on the rear surface 16 of the bib 12 as shown in FIG. 4, the protective layer 30 is positioned between the planar member 20 and the overlay 50. Alternatively, when the tag 218 is positioned on the front surface 14 of the bib 12 as shown in FIG. 5, the protective layer 30 is positioned between the planar member 20 and first water-proof layer 40.

The foregoing is provided for purposes of illustrating, explaining, and describing embodiments of the present invention. The specific components and order of the steps listed above, while preferred is not necessarily required. Further modifications and adaptation to these embodiments will be apparent to those skilled in the art and may be made without departing from the scope or spirit of the invention.

1. A disposable race bib timing device for attachment to a race participant's garments, comprising:
a thin, flexible planar sheet member having a front surface for displaying information, and a rear surface;
a plurality of RFID timing tags, each one of said RFID timing tags having a rear surface engaging one of either the front surface or rear surface of the thin flexible planar sheet member, said plurality of RFID timing tags being spaced a distance apart from one another and positioned in parallel in relation to one another; and
a thermal and moisture resistant layer of material positioned between each one of said plurality of RFID timing tags and said participant's garments.

2. The disposable race bib timing device according to claim 1, wherein said at least two RFID timing tags are affixed to the rear surface of the thin flexible planar sheet member.

3. The disposable race bib timing device according to claim 1, wherein said plurality of RFID timing tags comprises two RFID timing tags.

4. The disposable race bib timing device according to claim 1, wherein each of said plurality of RFID timing tags comprises:
a thin, flexible planar sheet member having a front surface, a rear surface;
a printed radio frequency identification (RFID) circuit disposed on one of said front or rear surfaces of the sheet member, said RFID circuit including an integrated circuit chip positioned near the center of the planar sheet member, and a dipole antenna electrically coupled to said integrated circuit chip, wherein a first dipole of the antenna extends generally along a longitudinal axis of the sheet member toward a first end thereof and a second dipole of the antenna extends generally along the longitudinal axis of the sheet member toward a second end thereof.

5. The disposable race bib timing device according to claim 4, wherein the first and second dipoles of the antenna extend substantially to the respective first and second ends of the flexible planar sheet.

6. The disposable race bib timing device according to claim 5, wherein the width of the first and second dipoles of said antenna extend substantially across the width of the flexible planar sheet member.

7. The disposable race bib timing device according to claim 4, wherein the RFID circuit is disposed on the rear surface of the sheet member.

8. The disposable race bib timing device according to claim 1, wherein the thermal and moisture resistant layer of material is comprised of closed cell foam.

9. The disposable race bib timing device according to claim 8, wherein the thermal and moisture resistant layer of material is between 10 and 12 mil in thickness.

10. The disposable race bib timing device according to claim 1 further comprising a water-proof layer of material positioned between said thin, flexible planar sheet member and each of said plurality of RFID timing tags.

11. The disposable race bib timing device according to claim 10 further comprising a water-resistant laminate material having a rear surface fully covering the plurality of RFID timing tags and the thermal and moisture resistant layer of material.

12. The disposable race bib timing device according to claim 11, wherein the thermal and moisture resistant layer of material is comprised of closed cell foam.

13. The disposable race bib timing device according to claim 12, wherein the thermal and moisture resistant layer of material is between 10 and 12 mil in thickness.

14. The disposable race bib timing device according to claim 1, wherein said RFID timing tags are positioned on a rear surface of the thin, flexible planar sheet member and said thermal and moisture resistant material has a rear surface engaging a front surface of each one of said RFID tags.

15. The disposable race bib timing device according to claim 14 further comprising a water-proof layer of material positioned between said thin, flexible planar sheet member and each of said plurality of RFID timing tags.

16. The disposable race bib timing device according to claim 15, further comprising a water-resistant laminate material having a rear surface engaging and fully covering a front surface of the thermal and moisture resistant layer of material.

17. The disposable race bib timing device according to claim 1, wherein said thermal and moisture resistant material is positioned on a front surface of the thin, flexible planar sheet member and said plurality of RFID tags each have a rear surface engaging a front surface of each one of said thermal and moisture resistant material layers.

18. The disposable race bib timing device according to claim 17 further comprising a water-proof layer of material positioned between said thin, flexible planar sheet member and each of said plurality of RFID timing tags.

19. The disposable race bib timing device according to claim 18 wherein said water-proof layer of material is positioned between said thin, flexible planar sheet member and said thermal and moisture resistant layer.

20. The disposable race bib timing device according to claim 19, further comprising a water-resistant laminate material having a rear surface engaging and fully covering a front surface of each of the plurality of RFID timing tags.
